(19) United States
(12) Patent Application Publication
(10) Pub. No.: US 2017/0123527 A1
(43) Pub. Date: May 4, 2017

(54) TOUCH DISPLAY SYSTEM, AND DRIVING APPARATUS AND DRIVING METHOD THEREOF

(71) Applicant: HIMAX TECHNOLOGIES LIMITED, Tainan City (TW)

(72) Inventors: Chen-Jung Chuang, Tainan City (TW); Jian-Ming Huang, Tainan City (TW)

(21) Appl. No.: 14/931,314

(22) Filed: Nov. 3, 2015

(51) Int. Cl. G06F 3/044

(52) U.S. Cl. CPC G06F 3/044

(57) ABSTRACT

A touch display system, and a driving apparatus and a driving method thereof are provided. The driving apparatus includes at least one gate driver, at least one source driver, a common voltage generator and a switching circuit. The gate driver drives the gate lines by turns in a scanning order. An output terminal of the common voltage generator outputs a common voltage. The switching circuit electrically connects a plurality of common lines of the touch display panel to the output terminal of the common voltage generator by turns according to the scanning order of the gate driver.

### BACKGROUND

Field of the Invention

The invention is directed to a display system and more particularly, to a touch display system and a driving apparatus and a driving method thereof.

Description of Related Art

In an in-cell touch display panel (which is referred to as a touch display panel hereinafter), common electrodes (which are capacitor electrodes shared by a plurality of pixels) serve as not only liquid crystal capacitors for providing a common voltage VCOM to the pixels in a display driving period, but also touch sensing electrodes in a touch driving period. A common voltage generator may provide the common voltage VCOM to the common electrodes in the touch display panel through the common lines in the display driving period.

According to a scanning sequence of the gate driver circuit scanning gate lines of the touch display panel, the source driver circuit may send a pixel data voltage into the corresponding pixels through the source lines of the touch display panel in the display driving period. However, parasitic capacitance usually occurs between the source lines and the common electrodes. An alternating current (AC) component of the signal transmitted in the source line is leaked to the common lines through the common electrodes, which a current increase to the common voltage generator. Moreover, source driver circuit would also result in a power consumption increase to the source driver circuit because the leakage from the AC component of the signal transmitted in the source lines to the common electrodes.

### SUMMARY

The invention provides a touch display system, and a driving apparatus and a driving method thereof to reduce current loading of a common voltage generator.

According to an embodiment of the invention, a driving apparatus of a touch display panel including at least one gate driver circuit, at least one source driver circuit, a common voltage generator and a switching circuit is provided. The gate driver circuit is coupled to a plurality of gate lines of the touch display panel. The gate driver circuit drives the gate lines by turns in a scanning order. The source driver circuit is coupled to a plurality of source lines of the touch display panel. The common voltage generator has an output terminal configured to output a common voltage. The switching circuit is electrically connected to the output terminal of the common voltage generator to receive the common voltage. The switching circuit electrically connects a plurality of common lines of the touch display panel to the output terminal of the common voltage generator by turns according to the scanning order of the gate driver circuit in a display driving period.

According to another embodiment of the invention, a driving method of a touch display panel is provided. The driving method includes: driving a plurality of gate lines of the touch display panel in a scanning order by at least one gate driver circuit; driving a plurality of source lines of the touch display panel by at least one source driver circuit; providing a common voltage by an output terminal of the common voltage generator; and electrically connecting a plurality of common lines of the touch display panel to the output terminal of the common voltage generator by turns according to the scanning order of the gate driver circuit by a switching circuit.

According to yet another embodiment of the invention, a touch display system including a touch display panel and a driving apparatus is provided. The touch display panel includes a plurality of gate lines, a plurality of source lines and a plurality of common lines. The driving apparatus includes at least one gate driver circuit, at least one source driver circuit, a common voltage generator and a switching circuit. The gate driver circuit is coupled to the gate lines. The gate driver circuit drives the gate lines by turns in a scanning order. The source driver circuit is coupled to the source lines. The common voltage generator has an output terminal configured to output a common voltage. The switching circuit is electrically connected to the output terminal of the common voltage generator to receive the common voltage. The switching circuit electrically connects the common lines to the output terminal of the common voltage generator by turns according to the scanning order of the gate driver circuit in a display driving period.

To sum up, in the touch display system, and the driving apparatus and the driving method thereof provided by the embodiments of the invention, the common lines of the touch display panel can be electrically connected to the output terminal of the common voltage generator and thereby, current loading of the common voltage generator can be effectively reduced.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic illustrating a circuit layout of an in-cell touch display panel.

FIG. 2 is a schematic circuit block diagram illustrating a touch display system according to an embodiment of the invention.

FIG. 3 is a flowchart illustrating a driving method of a touch display panel according to an embodiment of the invention.

### DESCRIPTION OF EMBODIMENTS

A term “couple (or connect)” used in the full text of the disclosure (including the claims) refers to any direct and indirect connections. For instance, if a first device is described to be coupled (or connected) to a second device, it is interpreted as that the first device is directly coupled to the second device, or the first device is indirectly coupled to the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

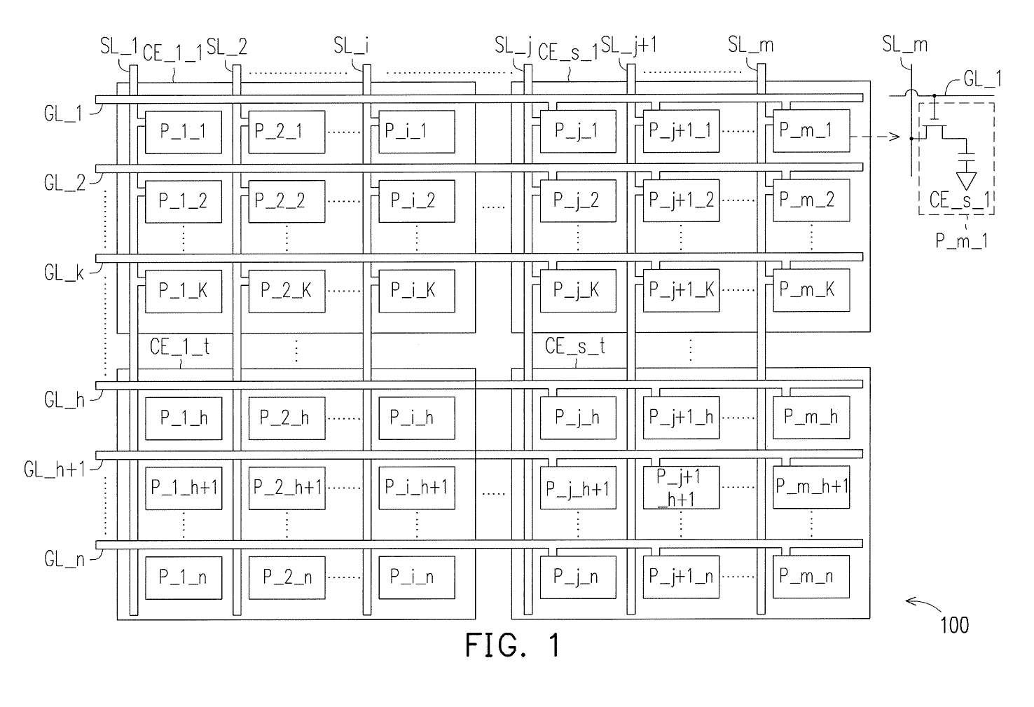

FIG. 1 is a schematic illustrating a circuit layout of an in-cell touch display panel (which is referred to as a touch display panel 100). FIG. 1 illustrates a touch display panel 100 formed by two substrates, in which a liquid crystal material is filled between the two substrates to serve as a liquid crystal layer. The touch display panel 100 is disposed with s*t common electrodes (e.g., common electrodes CE_1_1, CE_s_1, CE_1_t and CE_s_t shown in FIG. 1), m source lines (or referred to as data lines, e.g., source lines SL_1, SL_2, . . . and SL_i, . . . and SL_j, SL_j+1, . . . and SL_m shown in FIG. 1), n gate lines (gate line or referred to as scan lines, e.g., gate lines GL_1, GL_2, . . . and GL_k, . . . and GL_s, GL_s+1, . . . and GL_n shown in FIG. 1) m*n pixels (e.g., pixels P_1_1, P_2_1, . . . and P_i_1, . . . and P_j_1, P_j+1_1, . . . and P_m_1, P_1_2, P_2_2, . . . and P_i_2, . . . and P_j_2, P_j+1_2, . . . and P_m_2, . . . and P_1_k, P_2_k, . . . and P_i_k, . . . and P_j_k, P_j+1_k, . . . and P_m_k, . . . and P_1_h, P_2_h, . . . and P_1_h, . . . and P_j_h, P_j+1_h, . . . and P_m_h, P_1_h+1, P_2_h+1, . . . and P_i_h+1, . . . and P_j_h+1, P_j+1_h+1, . . . and P_m_h+1, . . . and P_1_n, P_2_n, . . . and P_in, . . . and P_j_n, P_j+1_n, . . . and P_m_n shown in FIG. 1). Therein, s, t, i, j, m, k, s and n are integers, and may be determined according to design requirements.

The source lines SL_1 to SL_m are perpendicular to the gate lines GL_1 to GL_n. The pixels P_1_1 to P_m_n are distributed in an array on the touch display panel 100. FIG. 1 illustrates an exemplary circuit diagram of the pixel P_m_1, and the other pixels may be so deduced according to the pixel P_m_1. A gate driver circuit (not shown) is coupled to the gate lines GL_1 to GL_n of the touch display panel 100. The gate driver circuit is configured to drive (scan) each of the gate lines GL_1 to GL_n by turns in a display driving period. A source driver circuit (not shown) is coupled to the source lines SL_1 to SL_m of the touch display panel 100. According to a scanning sequence/order of the gate driver circuit (not shown), the source driver circuit may write a source driving signal into the plurality of pixels of the touch display panel 100 in the display driving period, so as to display an image.

In a touch driving period, the common electrodes CE_1_1 to CE_s_t may serve as sensing electrodes of the touch panel. A driving apparatus (not shown) may output a driving signal to driving electrode lines (e.g., the source lines SL_1 to SL_m or additionally disposed lines) of the touch display panel 100 in the touch driving period, and the driving apparatus may sense the common electrodes CE_1_1 to CE_s_t in the touch driving period, so as to detect a touch event of the touch display panel 100.

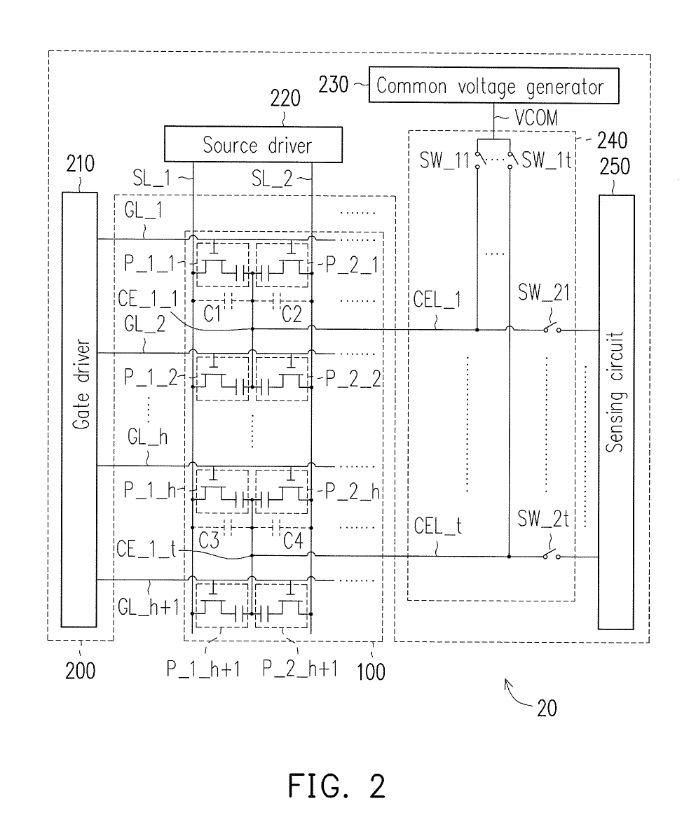

FIG. 2 is a schematic circuit block diagram illustrating a touch display system 20 according to an embodiment of the invention. A touch display system 20 includes a touch display panel 100 and a driving apparatus 200. The touch display panel 100 illustrated in FIG. 2 may refer to the description with respect to the touch display panel 100 illustrated in FIG. 1 and thus, will not be repeatedly described. The driving apparatus 200 includes at least one gate driver circuit 210, at least one source driver circuit 220, a common voltage generator 230, a switching circuit 240 and a sensing circuit 250. The gate driver circuit 210 is coupled to gate lines GL_1 to GL_n (e.g., gate lines GL_1, GL_2, GL_h and GL_h+1 shown in FIG. 2). The gate driver circuit 210 may drive the gate lines GL_1 to GL_n by turns according to a scanning order. The source driver circuit 220 is coupled to source lines SL_1 to SL_m (e.g., source lines SL_1 and SL_2 shown in FIG. 2). According to a scanning sequence/order of the gate driver circuit 210, the source driver circuit 220 may write a source driving signal into a plurality of pixels of the touch display panel 100 through the source lines SL_1 to SL_m in a display driving period, so as to display an image.

The common voltage generator 230 has an output terminal configured to output a common voltage VCOM. The switching circuit 240 is electrically connected to the output terminal of the common voltage generator 230 to receive the common voltage VCOM. The switching circuit 240 is electrically connected to common lines (e.g., common lines CEL_1 . . . and CEL_t shown in FIG. 2) of the touch display panel 100. The switching circuit 240 may selectively electrically connect one or multiple of the common lines CEL_1 to CEL_t to the output terminal of the common voltage generator 230 in a display driving period. The switching circuit 240 may selectively electrically connect the common lines CEL_1 to CEL_t to the sensing circuit 250 in a touch driving period. According to different design requirements, the switching circuit 240 may be an arbitrary routing circuit or switching circuit, such as a switch, a demultiplexer or the like.

In some application scenarios, the switching circuit 240 may simultaneously electrically connect all the common lines CEL_1 to CEL_t to the output terminal of the common voltage generator 230, such that the common voltage VCOM may be transmitted to all common electrodes CE_1_1 to CE_s_t (e.g., common electrodes CE_1_1, . . . and CE_1_t shown in FIG. 2) through the common lines CEL_1 to CEL_t simultaneously in the display driving period. Parasitic capacitance commonly forms between each of the source lines SL_i to SL_m and each of the common electrodes CE_1_1 to CE_s_t. A parasitic capacitance C1 forms between the source line SL_1 and the common electrode CE_1_1, a parasitic capacitance C2 forms between the source line SL_2 and the common electrode CE_1_1, a parasitic capacitance C3 forms between the source line SL_1 and the common electrode CE_1_t, and a parasitic capacitance C4 forms between the source line SL_2 and the common electrode CE_1_t. An AC component of a signal transmitted in the source lines SL_1 to SL_m may be leaked to the common lines CEL_1 to CEL_t though the parasitic capacitance and the common electrodes CE_1_1 to CE_s_t, which causes a current increase to the common voltage generator 230. Moreover, the leakage from the AC component of the signal transmitted in the source lines SL_1 to SL_m to the common electrodes CE_1_1 to CE_s_t would also result in a power consumption increase to the source driver circuit 220.

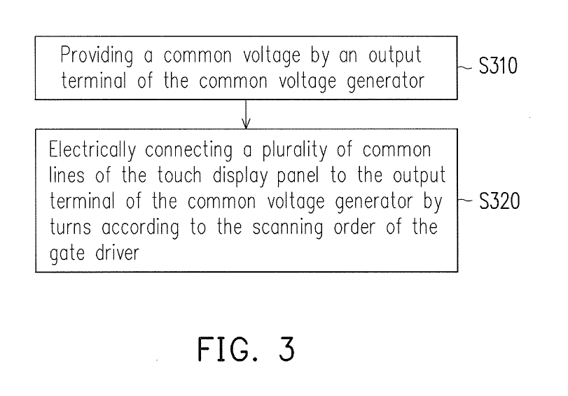

FIG. 3 is a flowchart illustrating a driving method of a touch display panel according to an embodiment of the invention. Referring to FIG. 1 to FIG. 3, in the present embodiment, the output terminal of the common voltage generator 230 provides the common voltage VCOM to the switching circuit 240 (step S310). In addition, the gate driver circuit 210 drives (scans) the gate lines GL_1 to GL_n of the touch display panel 100 according to a specific scanning order. According to the scanning sequence/order of the gate driver circuit 210, the source driver circuit 220 drives the source lines SL_1 to SL_m of the touch display panel 100 to write the source driving signal into the pixels of the touch display panel 100. The switching circuit 240 may selectively electrically connect the common lines CEL_1 to CEL_t of the touch display panel 100 to the output terminal of the common voltage generator 230 by turns according to the scanning order of the gate driver circuit 210 (step S320).

Referring to FIG. 1 and FIG. 2, the gate lines GL_1 to GL_n are grouped into a plurality of gate line groups based configuration positions of the common electrodes CE_1_1 to CE_s_t, and the gate line groups are one-to-one corresponding to the common lines CEL_1 to CEL_t. For example, the gate lines GL_1 to GL_k illustrated in FIG. 1 are grouped into the same gate line group, and the gate line group is corresponding to the common line CEL_1, and likewise, the gate lines GL_h to GL_n illustrated in FIG. 1 are grouped into another gate line group, and the gate line group is corresponding to the common line CEL_t.

In step S320, when one of the gate lines belonging to a scanned gate line group among the gate line groups is scanned by the gate driver circuit 210, the switching circuit 240 selectively electrically connects a common line corresponding to the scanned gate line group among the common lines CEL_1 to CEL_t to the output terminal of the common voltage generator 230 and selectively electrically disconnect the rest of the common lines among the common lines CEL_1 to CEL_t from the output terminal of the common voltage generator 230. For example, when one of the gate lines GL_1 to GL_k is scanned by the gate driver circuit 210, the switching circuit 240 selectively electrically connects the common line CEL_1 to the output terminal of the common voltage generator 230 and selectively electrically disconnects the rest of the common lines (e.g., the common lines CEL_t) from the output terminal of the common voltage generator 230. In the same way, when one of the gate lines GL_h to GL_n is canned by the gate driver circuit 210, the switching circuit 240 selectively electrically connects the common line CEL_t to the output terminal of the common voltage generator 230 and selectively electrically disconnects the rest of the common lines (e.g., the common line CEL_1) from the output terminal of the common voltage generator 230.

Because the switching circuit 240 is capable of electrically connecting the common lines CEL_1 to CEL_t of the touch display panel 100 by turns to the output terminal of the common voltage generator 230 according to the scanning order of the gate driver circuit 210, the AC component of the signal transmitted in the source lines SL_1 to SL_m is leaked to only a small part of the common lines through a small part of the common electrodes. For example, when the switching circuit 240 selectively electrically connect the common line CEL_1 to the output terminal of the common voltage generator 230, the rest of the common lines (e.g., the common line CEL_t) are in a floating state (which are electrically disconnected from the output terminal of the common voltage generator 230), such that the AC component of the signal transmitted in the source lines SL_1 to SL_m is not leaked to the common voltage generator 230 through the rest of the common lines (e.g., the common line CEL_t). In the same way, when the switching circuit 240 selectively electrically connect the common line CEL_t to the output terminal of the common voltage generator 230, the rest of the common lines (e.g., common lines CEL_1) is in the floating state (which is electrically disconnected from the output terminal of the common voltage generator 230), such that the AC component of the signal transmitted in the source lines SL_1 to SL_m is not leaked to the common voltage generator 230 through the rest of the common lines (e.g., the common line CEL_1). Thus, a current of the common voltage generator 230 may be effectively reduced. Moreover, since the AC component of the signal of the source lines SL_1 to SL_m is not leaked to the common electrodes in the floating state, the power consumption of the source driver circuit 220 may be effectively saved.

In the embodiment illustrated in FIG. 2, the switching circuit 240 includes a plurality of switches (e.g., switches SW_11, . . . and SW_1t and switches SW_21, . . . and SW_2t illustrated in FIG. 2). The switches SW_21 to SW_2t are turned off in the display driving period. First terminals of the switches SW_11 to SW_1t are electrically connected in common the output terminal of the common voltage generator 230 to receive the common voltage VCOM. Second terminals of the switches SW_11 to SW_1t are electrically one-to-one connected to the common lines CEL_1 to CEL_t. When one of the gate lines belonging to a scanned gate line group among the gate line groups is scanned by the gate driver circuit 210, one of the switches SW_11 to SW_1t is turned on to electrically connect a common line among the common lines CEL_1 to CEL_t corresponding to the scanned gate line group to the output terminal of the common voltage generator 230, and the others of the switches SW_11 to SW_1t are turned off to electrically disconnect the others of the common lines CEL_1 to CEL_t from the output terminal of the common voltage generator 230. For example, when one of the gate lines GL_1 to GL_k is scanned by the gate driver circuit 210, the switch SW_11 is turned on to electrically connect the common line CEL_1 to the output terminal of the common voltage generator 230, and the other switches (e.g., the switch SW_1t) of the switches SW_11 to SW_1t in the switching circuit 240 are turned off to electrically disconnect the rest of the common lines (e.g., the common line CEL_t) from the output terminal of the common voltage generator 230. In the same way, when one of the gate lines GL_h to GL_n is scanned by the gate driver circuit 210, the switch SW_1t is turned on to electrically connect the common line CEL_t to the output terminal of the common voltage generator 230, and the other switches (e.g., the switch SW_11) of the switches SW_11 to SW_1t in the switching circuit 240 are turned off to electrically disconnect the rest of the common lines (e.g., the common line CEL_1) from the output terminal of the common voltage generator 230.

The sensing circuit 250 has a plurality of input terminals electrically one-to-one connected to the first terminals of the switches SW_21 to SW_2t, and the second terminals of the switches SW_21 to SW_2t are electrically one-to-one connected to the common lines CEL_1 to CEL_t. The switches SW_21 to SW_2t are turned on in the touch driving period, and the switches SW_11 to SW_1t are turned off in the touch driving period. The sensing circuit 250 senses the common electrodes CE_1_1 to CE_s_t of the touch display panel 100 through the common lines CEL_1 to CEL_t in the touch driving period, so as to detect the touch event of the touch display panel 100. According to different design requirements, the sensing circuit 250 may employ different touch sensing operations. For example (but not limited to), the sensing circuit 250 may employ the conventional touch sensing operation and thus, will not be repeatedly described.

To summarize, in the embodiments of the invention, the touch display system, and the driving apparatus and the driving method thereof can contribute to electrically connecting the plurality of common lines CEL_1 to CEL_t of the touch display panel 100 to the output terminal of the common voltage generator by turns, and thereby, the current loading of the common voltage generator can be effectively reduced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A driving apparatus of a touch display panel, comprising:
at least one gate driver circuit, coupled to a plurality of gate lines of the touch display panel, wherein the at least one gate driver circuit drives the gate lines by turns in a scanning order;
at least one source driver circuit, coupled to a plurality of source lines of the touch display panel;
a common voltage generator, having a output terminal configured to output a common voltage; and
a switching circuit, electrically connected to the output terminal of the common voltage generator to receive the common voltage, wherein the switching circuit electrically connects a plurality of common lines of the touch display panel to the output terminal of the common voltage generator by turns according to the scanning order of the gate driver circuit in a display driving period.

2. The driving apparatus according to claim 1, wherein the gate lines are grouped into a plurality of gate line groups, the gate line groups are one-to-one corresponding to the common lines, when one of the gate lines belonging to a scanned gate line group among the gate line groups is scanned by the gate driver circuit, the switching circuit selectively electrically connects one of the common lines which is corresponding to the scanned gate line group to the output terminal of the common voltage generator, and selectively electrically disconnects the rest of the common lines from the output terminal of the common voltage generator.

3. The driving apparatus according to claim 1, wherein the switching circuit comprises:
a plurality of switches, having first terminals electrically connected in common to the output terminal of the common voltage generator to receive the common voltage, and second terminals electrically one-to-one connected to the common lines,
wherein when one of the gate lines belonging to a scanned gate line group among the gate line groups is scanned by the gate driver circuit, one of the switches is turned on to electrically connect one of the common lines which is corresponding to the scanned gate line group to the output terminal of the common voltage generator, and the others of the switches are turned off to electrically disconnect the rest of the common lines from the output terminal of the common voltage generator.

4. The driving apparatus according to claim 1, further comprising:
a sensing circuit, having a plurality of input terminals electrically one-to-one connected to the common lines, and configured to sense a plurality of common electrodes of the touch display panel through the common lines in a touch driving period, so as to detect a touch event of the touch display panel.

5. A driving method of a touch display panel, comprising:
driving a plurality of gate lines of the touch display panel in a scanning order by at least one gate driver circuit;
driving a plurality of source lines of the touch display panel by at least one source driver circuit;
providing a common voltage by an output terminal of the common voltage generator; and
electrically connecting a plurality of common lines of the touch display panel to the output terminal of the common voltage generator by turns according to the scanning order of the gate driver circuit by a switching circuit.

6. The driving method according to claim 5, wherein the gate lines are grouped into a plurality of gate line groups, the gate line groups are one-to-one corresponding to the common lines, and the step of electrically connecting the common lines to the output terminal of the common voltage generator by turns comprises:
when one of the gate lines belonging to a scanned gate line group among the gate line groups is scanned by the gate driver circuit, selectively electrically connecting one of the common lines which is corresponding to the scanned gate line group to the output terminal of the common voltage generator, and selectively electrically disconnecting the rest of the common lines from the output terminal of the common voltage generator by the switching circuit.

7. The driving method according to claim 5, further comprising:
sensing a plurality of common electrodes of the touch display panel through the common lines in a touch driving period by a sensing circuit, so as to detect a touch event of the touch display panel.

8. A touch display system, comprising:
a touch display panel, comprising a plurality of gate lines, a plurality of source lines and a plurality of common lines; and
a driving apparatus, the driving apparatus comprising:
at least one gate driver circuit, coupled to the gate lines, wherein the at least one gate driver circuit drives the gate lines by turns in a scanning order;
at least one source driver circuit, coupled to the plurality of source lines;
a common voltage generator, having a output terminal configured to output a common voltage; and
a switching circuit, electrically connected to the output terminal of the common voltage generator to receive the common voltage, wherein the switching circuit electrically connects the common lines to the output terminal of the common voltage generator by turns according to the scanning order of the gate driver circuit in a display driving period.

9. The touch display system according to claim 8, wherein the gate lines are grouped into a plurality of gate line groups, the gate line groups are one-to-one corresponding to the common lines, when one of the gate lines belonging to a scanned gate line group among the gate line groups is scanned by the gate driver circuit, the switching circuit selectively electrically connects one of the common lines which is corresponding to the scanned gate line group to the output terminal of the common voltage generator, and selectively electrically disconnects the rest of the common lines from the output terminal of the common voltage generator.

10. The touch display system according to claim 8, wherein the switching circuit comprises:
a plurality of switches, having first terminals electrically connected in common to the output terminal of the common voltage generator to receive the common voltage, and second terminals electrically one-to-one connected to the common lines,
wherein when one of the gate lines belonging to a scanned gate line group among the gate line groups is scanned by the gate driver circuit, one of the switches is turned on to electrically connect one of the common lines which is corresponding to the scanned gate line group to the output terminal of the common voltage generator, and the others of the switches are turned off to electrically disconnect the rest of the common lines from the output terminal of the common voltage generator.

11. The touch display system according to claim 8, wherein the driving apparatus further comprising:
a sensing circuit, having a plurality of input terminals electrically one-to-one connected to the common lines, and configured to sense a plurality of common electrodes of the touch display panel through the common lines in a touch driving period, so as to detect a touch event of the touch display panel.
